(19) United States
(12) Patent Application Publication
(10) Pub. No.: US 2008/0022542 A1
(43) Pub. Date: Jan. 31, 2008

(54) Template cutting assembly with hinged frame

(75) Inventors: Sean Brosmith, Beverly Hills, CA (US); Harald Belker, Marina Del Rey, CA (US)

Correspondence Address: GREER, BURNS & CRAIN, 300 S WACKER DR, 25TH FLOOR, CHICAGO, IL, 60606, US

(73) Assignee: Helix USA

(21) Appl. No.: 11/496,206

(22) Filed: Jul. 31, 2006

(51) Int. Cl. G01B 3/14

(52) U.S. Cl. 33/562

(57) ABSTRACT

A template cutting assembly is designed for cutting a sheet medium and includes a base and a frame connected by a hinge assembly. The base has a first end and a second end, the first end providing a hinge attachment point for the base. Likewise, the frame has a first end and a second end with the first end being the hinge end. A cutting surface is mounted on the base, and a template is removably mounted on the frame. The template has at least one guide channel for guiding a knife blade for cutting the medium.

### BACKGROUND OF THE INVENTION

The present invention generally relates to devices used for cutting sheet material such as photos, colored backing paper, and the like into selected shapes. More specifically, the present relates to the use of templates for cutting such shapes in conjunction with arts and crafts activities such as scrapbooking.

The use of a template as a cutting guide is well known. For example, U.S. Pat. No. 6,321,457 describes a cutting template and a method for using it. The '457 patent describes a translucent planar template having guide channels arranged in geometric shapes or patterns. A piece of sheet material, such as a picture or piece of paper, is placed on a planar cutting surface, such as a table, counter, piece of plastic, or the like. Next, the template is pressed onto the sheet material, trapping the sheet material between the template and the planar surface. Typically, a knife or specialized cutter is provided for use with the template.

A user would place the knife against an edge of the guide channels, and then draw the knife along the edge of the guide channel, thereby cutting the sheet material into the desired shape. As different template designs would be desired, the '457 patent teaches the concept of interchanging templates by lifting off the first template and trapping the sheet material with a new template having a different design.

Other prior art teaches similar devices in which the template is firmly and more securely mounted onto a base, having a cutting surface. Such a mounting can be in the form of fasteners such as bolts, screws, or the like. First, the sheet material is placed on the cutting surface. Next, the template is mounted onto the base, firmly trapping the sheet material between them. Such a mounting system more firmly traps the sheet material and better prevents it from moving during cutting operations. Finally, a knife or cutter is provided and is drawn through the grooves, in a similar fashion as above.

However, a perceived disadvantage of the '457 patent was its failure to provide both a mechanism for anchoring the template while retaining template interchangeability. Furthermore, the prior art is somewhat deficient in allowing the template to be interchanged, without disturbing the material being cut. Any disturbance in the position of the material may result in subsequent cuts not aligning properly with older cuts. Another perceived disadvantage in the prior art is the cutting surface often becomes scratched, rough, or uneven over time. A final perceived disadvantage in the prior art is the inconsistency and nonrepeatability of cuts due to variations in the position of the knife against the edge from one cut to another.

Thus a need exists for an improved template cutting assembly configured for use with an interchangeable, anchored template. Furthermore, a need exists for an improved template cutting assembly providing template interchangeability that limits disturbance to the material being cut. A need also exists for an improved template cutting assembly addressing the disadvantages discussed above.

### SUMMARY OF THE INVENTION

The above-listed needs are met or exceeded by the present template cutting assembly with a hinged frame. To allow both interchangeability and secureability of a template to a base, a frame is attached to the base, and is configured so that a user can slideably engage the template in the frame. A hinge assembly connects the base and frame, and allows the frame, with the engaged template, to be positioned substantially flush against the base, directly above a cutting surface, in a “closed” position. To more securely keep the frame in the closed position during use, the template cutting assembly has a locking mechanism. After use, the frame can be pivoted, into a more “open” position, away from the base. Then, the template can be slideably disengaged from the frame. Thus, the template cutting assembly anchors the template to the base, while providing template interchangeability.

Furthermore, the template cutting assembly has a ratcheting hinge that is configured to suspend the frame at varying degrees of openness. This results in less disturbance to the sheet material on the cutting surface when the templates are slideably engaged and disengaged. The present template cutting assembly also provides a removable cutting surface. The base has a recessed center, into which the removable cutting surface is placed. As an older cutting surface becomes scratched and damaged, it may be removed and a new one inserted. Finally, to improve cutting consistency, the template cutting assembly has guide channels that are beveled, and a specially designed knife. The knife has a curved blade holder, configured such that the curvature of the blade holder corresponds to the curve of the beveling. The blade holder also rotates about a central axis of the knife. This reduces a users need to constantly realign the knife to keep the blade holder and the beveling flush.

More specifically, a template cutting assembly provided for cutting a medium includes a base and a frame connected by a hinge assembly for respective movement between a closed, cutting position and an open position. The base has a first end and a second end, the first end providing a hinge attachment point for the base. Likewise, the frame has a first end configured for engaging the hinge attachment point, and a second end. The template is removably mounted on the frame and has at least one guide channel for guiding a knife blade for cutting the medium.

In another embodiment, a template cutting assembly includes a system for cutting a medium that includes a base and a frame connected by a hinge assembly for respective movement between a closed, cutting position and an open position. The base has a first end and a second end, the first end providing a hinge attachment point for the base. Likewise, the frame has a first end configured for engaging the hinge attachment point, and a second end. A cutting surface is mounted on the base and the template is removably mounted on the frame. The template has at least one guide channel for guiding a knife blade for cutting the medium. The system also includes a knife with a handle and a blade housing. The blade housing has a complementary contoured surface configured for engaging a corresponding edge of the template.

In a further embodiment, a template cutting assembly includes a knife provided for use with a template system for cutting a medium. The system includes at least one template having at least one guide channel with a beveled edge. The knife has a handle with a first end and a second end, with a grip area disposed between the ends, and having a hollow interior. The knife also has a blade housing releasably attached to the first end. This blade housing has an edge portion contoured to be complementary to the beveled edge. Finally, the blade housing has an axial shaft projecting into the hollow interior that is configured for being rotatably engaged and secured in the interior.

### BRIEF DECRIPTION OF THE DRAWINGS

FIG. 1 is an overhead perspective of the template cutting assembly in a closed position;

FIG. 2 is an overhead perspective of the template cutting assembly in an open position;

FIG. 3 is an exploded view of FIG. 2;

FIG. 4 is a bottom plan view of the frame;

FIG. 5 is a bottom plan view of the base;

FIG. 6 is an exploded view of the present hinge assembly;

FIG. 7 is a partial elevated cross-section of the present hinge assembly;

FIG. 8 is a fragmentary vertical cross-section of the template cutting assembly in the closed position;

FIG. 9 is an elevational view of a knife suitable for use with the present template cutting assembly;

FIG. 10 is a cross-section taken along the line 10-10 of FIG. 9 in the direction generally indicated; and

FIG. 11 is an exploded view of the knife of FIG. 9.

### DETAILED DESCRIPTION OF THE INVENTION

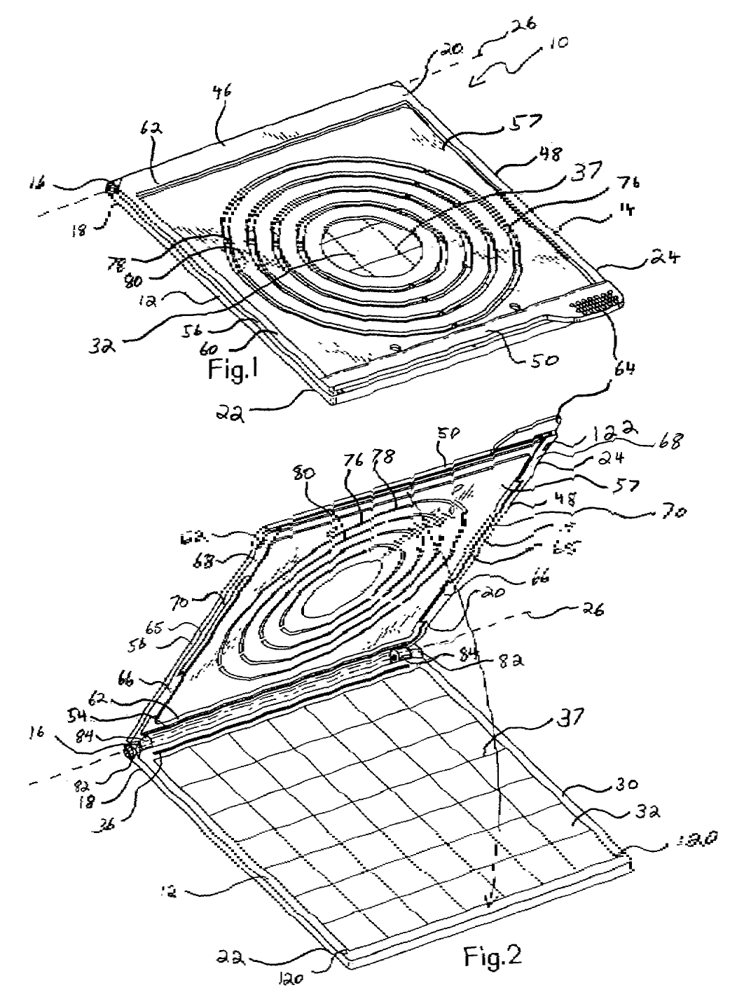

Referring to FIGS. 1-2, the present template cutting assembly is generally designated 10 and includes a base 12 and a frame 14 that are connected by a hinge assembly 16. Both the base 12 and the frame 14 have corresponding hinge ends 18 and 20 and opposite respective outer ends 22 and 24. The base 12 is typically laid flat upon a substrate such as a table, counter, or the like during use, and the frame 14 pivots along a hinge assembly axis 26. For definitional purposes, a “closed” or “cutting position” will be defined as when the frame 14 and base 12 are substantially flush together, as shown in FIG. 1. Furthermore, as the frame 14 pivots away from this position, it becomes more open, such as in FIG. 2. Lastly, a “topside” and an “underside” of the frame 14 and the base 12 are defined relative to the depiction of FIG. 1, in which an underside of the frame 14 meets a topside of the base 12 in the closed position.

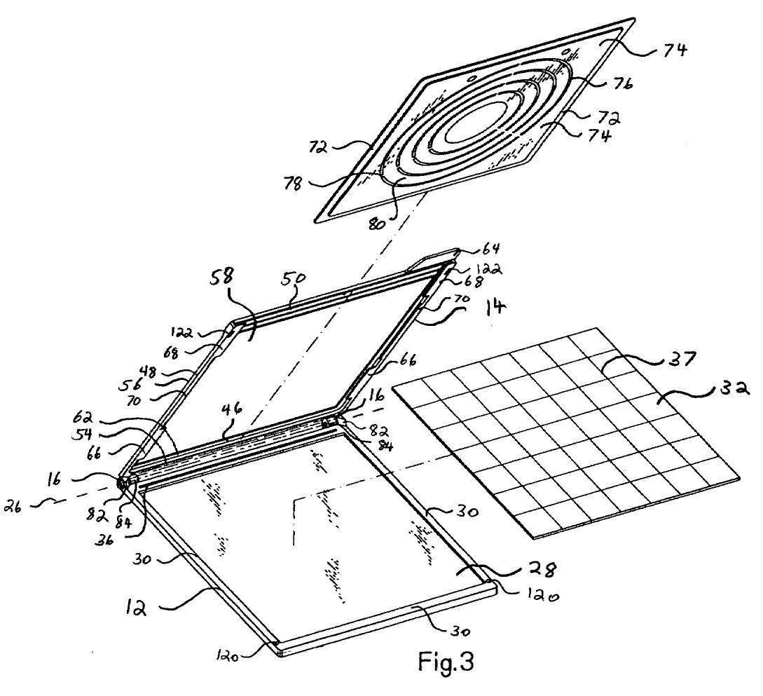

Referring now to FIG. 3, the base 12 is preferably made of a single piece of molded plastic, although other materials and other plastic manufacturing techniques may be used as well. The base 12 is preferably relatively rigid, with little flexibility or compression during normal use. A recessed center 28 is defined by a raised base rim 30, preferably in a square shape, although other shapes are contemplated. A removable cutting surface 32 has dimensions substantially the same as the recessed center 28 in length, width, and height. Thus, when the cutting surface 32 is inserted into the base 12, a generally planar surface is created by the two components, which in turn allows the frame 14 to flushly close into the cutting position. The tight engagement of the cutting surface 32 in the recessed center 28 also prevents the cutting surface 32 from moving during use.

To facilitate more precise placement of the sheet material to be cut, preferably a picture or piece of paper, a guide rail 36 rises above the base rim 30 on the hinge end 18, and is generally parallel to the hinge axis 26. The guide rail 36 provides a straight edge against which the edge of a piece of sheet material to be cut can be flushly placed. In the preferred embodiment, to further assist precise placement, the cutting surface 32 has a grid 37 of vertical and horizontal lines. The cutting surface 32 is preferably made out of a material with the following combination of attributes: flexibility, planar smoothness, resistance to scratching, resistance to wear, and limited tensile compressibility.

Referring now to FIG. 5, an underside 38 of the base 12 of the preferred embodiment is shown in further detail. For definitional purposes, this paragraph will refer to “raised” and “lowered” sections as if the entire base 12 was inverted. An outer rim 40 is buttressed by at least one, and preferably two ribs 42 in both the horizontal and vertical directions. These ribs 42 preferably have the same height as the outer rim 40, thus providing further support for the base 12 underlying the cutting surface 32. Within the outer rim 40, a gutter 43 borders a raised center area 44. This raised center area 44 has a height, length, and width greater than the cutting surface 32, because the raised center area 44 is actually the bottom surface of the recessed center 28 (shown hidden). By leaving portions of the base 12 hollow, weight and material are saved. However, the ribs enhance the stability and structural integrity of the base 12.

Referring now to FIGS. 1, 2, 4, and 8, the frame 14 is defined by a back piece 46, at least one, but preferably two side bars 48 extending from the back piece, and preferably a front piece 50 connecting the side bars 48 at the outer end 24. The frame 14 is preferably manufactured out of molded plastic, and substantially forms a square, however, other materials, manufacturing methods, and shapes are contemplated. Using the reference frame of FIGS. 1 and 2, a backstop 54 and side edges 56 each extend downward from the underside of the back piece 46 and the side bars 48 respectively. Together the backstop 54 and the side edges 56 form a rim along the underside of the frame 14. It can be seen that the height (“H”) of the side edges 56 is greater than the thickness (“T”) of a template 57, (FIG. 8). Likewise, a space 58 defined by the backstop 54 and the side edges 56 is dimensioned to slidingly, yet snugly, accommodate the template 57. However, the length of the back piece 46 and side bars 48 are greater than the length of the template 57.

Referring now to FIG. 8, an over-rail 60 extends horizontally from the topside of the side edge 56. A back over-rail 62 can be seen starting from the topside, hinge end of the frame 14 (FIG. 1) extending horizontally beyond the backstop 54, and topside above the space 58 for the template 57 (FIG. 5). A handle 64 extends further outward from the outer end 22 of the front piece 50 to assist in opening and closing the frame 14. In preferred embodiments, the top surface of the handle 64 is textured for ease of use.

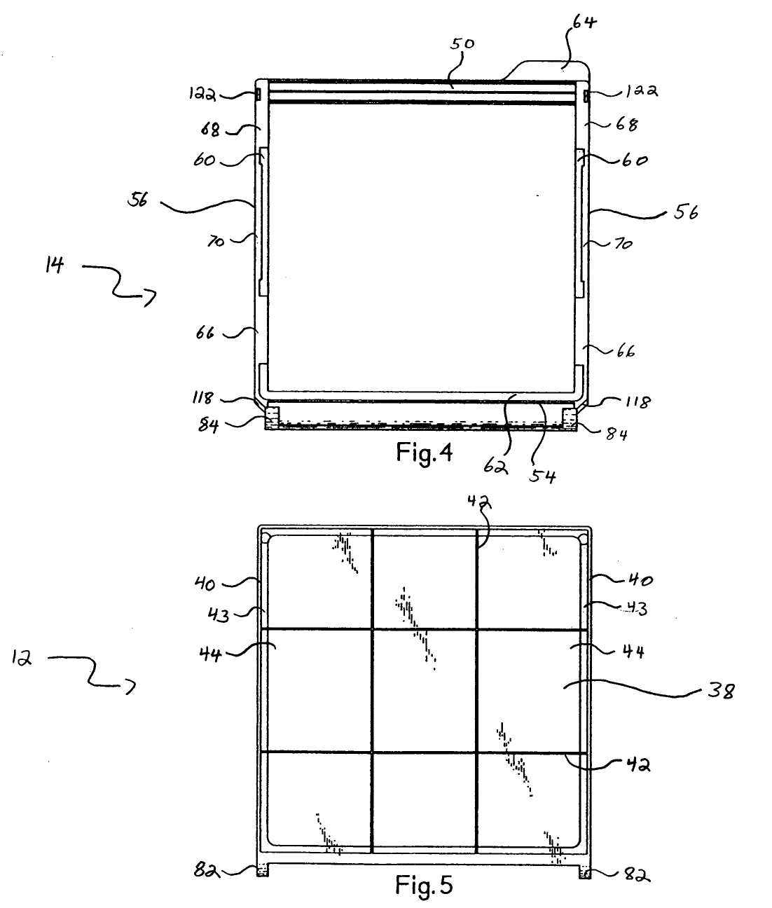

Referring now to FIGS. 4 and 8, an under-rail 65 extends from underside of the side edge 56 to form a sliding track 69 for the template 57 (FIG. 8). The under-rail 65 preferably is formed by three separate tabs; 66, 68, and 70; although other configurations such as a single piece are contemplated. A hinge end tab 66 and an outer end tab 68 have substantially the same dimensions. Each is preferably one inch long; and each has a width, extending towards the center, substantially the same as the width (“W”) of a template rim 72, which will be defined and discussed in greater detail below. The common dimensions aid in providing sliding support for the template 57. A third middle tab 70 has a longer length, but a shorter width. The side edge 56, the over-rail 60, and the under-rail 65 define the track 69, into which the template rim 72 is slid. This track 69 has substantially the same thickness as the template rim 72, as shown in FIG. 8.

The template 57 is preferably manufactured out of a translucent plastic material, such as integrally molded plastic, however, other fabrication methods and materials are also contemplated. This material is preferably rigid during normal use, but should have some amount of flexibility. In the embodiment shown, the template 57 is generally square shaped, although other configurations are contemplated. The template rim 72 has a width (“W”) shown in FIG. 8, and is thinner than a center area 74. The template rim 72 is designed to allow the edge of the template 57 to fit into the track 69.

Referring now to FIGS. 3 and 8, guide channels 76 are arranged in some pattern or design about the template 57, as depicted the guide channels form concentric circles. The guide channels 76 are cut through the entire thickness of the template center area 74, and are preferably beveled. The beveling is best illustrated in FIG. 8, and results in the guide channels 76 being wider on the topside than the underside.

Referring back to FIG. 3, the guide channels 76 are interrupted by at least one, and preferably three, sets of supporting connectors 78. The connectors 78 are necessary to support interior material 80 within the circumference of any concentric circle. However, the supporting connectors necessarily interrupt the continuity of the guide channels 76, and therefore can interfere with a cut. To allow for more precise cuts, the connectors 78 are preferably arranged at intervals of 120 degrees. This allows the template 57 to be removed from the frame 14, rotated ninety degrees, and placed back in the frame 14 presenting open guide channels 76 in the areas previously obscured by the connectors 78.

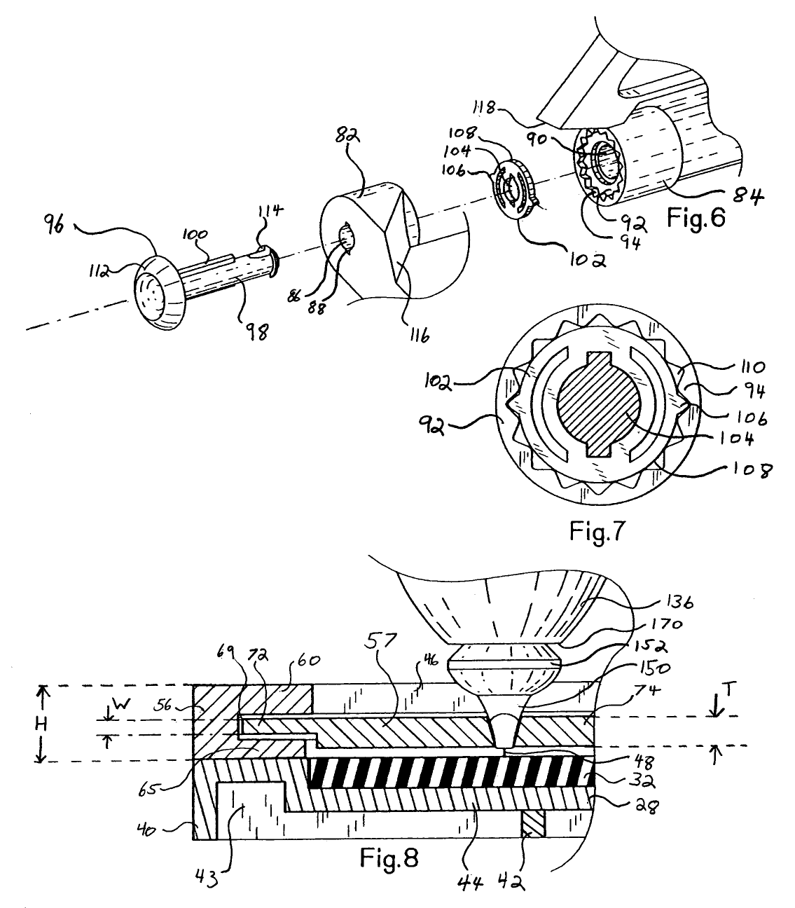

Referring now to FIGS. 6 and 7, the hinge assembly 16 of a preferred embodiment is shown in more detail. The base 12 has two hinge barrels (“base barrels”) 82 associated with both corners of its hinge end 18, likewise the frame 14 has two hinge barrels (“frame barrels”) 84 associated with either end of its hinge end 20. In the base barrels 82, a central bore 86 has at least one, but preferably two, radially extending diametrically opposed cavities 88 in communication with the central bore 86, to form a keyway. In the frame barrel 84, a frame bore 90 is counterbored, and a counterbore 92 has a ridged, or ratchet-like, inner peripheral edge 94. A hinge pin 96 has a shaft 98 with at least one flange 100 extending radially to form a key that generally corresponds to the dimensions of the lateral cavities or keyway 88. Preferably, the number of flanges 100 will equal the number of lateral cavities 88. Thus, upon insertion of the pin 96 into the base barrel 82, the engagement of the flanges 100 in the lateral cavities 88 prevents relative rotation of the pin and the barrel.

A washer 102 has an inner washer bore 104 whose dimensions slidingly match the dimensions of the shaft 98, including space for the flanges 100. At least one, and preferably two gear teeth 106 extend outward from an outer circumference 108 of the washer 102. The dimensions of the circumference 108 and the gear teeth 106 are generally complementary to the dimensions of the ridged inner periphery 94 of the counterbore 92, such that the gear teeth 106 partially extend into spaces 110 defined by the ridges of the inner periphery 94.

When assembled, the washer 102 is placed within the counterbore 92 and the hinge pin 96 is inserted into the base bore 86 from the outside of the base barrel 82. The shaft 98 extends all the way through the base barrel 82, the washer 102, and the frame barrel 84. When the frame 14 is pivoted, the pin 96 is prevented from rotating because the lateral cavities 88 prevent the rotation of the flanges 100. This in turn prevents the washer 102 from rotating. Thus, as the frame barrel 84 rotates, the ridges of the counterbore 92 are partially impinged by the gear teeth 106. Rotation is thus retarded in the absence of outside force provided by the user. In this way, a plurality of interim open positions are achievable with the present frame 14. The pin 96 is preferably manufactured out of molded plastic, although other materials and manufacturing techniques will suffice. Furthermore, the pin 96 also has a cap 112 and at least one, preferably two, lips 114 to retard pin 96 slippage out of the hinge assembly 16. Such a hinge assembly is referred to here as a ratcheting hinge.

Referring now to FIGS. 1 and 6, another feature of the present template cutting assembly 10 is that the base barrel 82 has a slanted cut 116 in its outer surface. The frame 14 has a substantially complementary slanted cut 118 in either hinge end 20 corner. Thus, when in the closed position the two slanted cuts 116, 118 meet in a generally flush manner. Because the cuts are slanted, lateral movement of the frame 14 in the closed position is thus significantly retarded.

Referring now to FIG. 2, when in the cutting position, the frame 14 and the base 12 are preferably maintained in a locking relationship by a locking mechanism made up of at least one, and preferably two pairs of matched magnets 120, 122. The magnets 120, 122 are arranged in the corners of the outer ends 22, 24 of the base and frame respectively and are aligned such that when the frame 14 is closed they lie substantially flush and attract each other, thus more firmly holding the frame 14 in the closed or cutting position. Other types and locations of non-magnetic locking mechanisms are also contemplated.

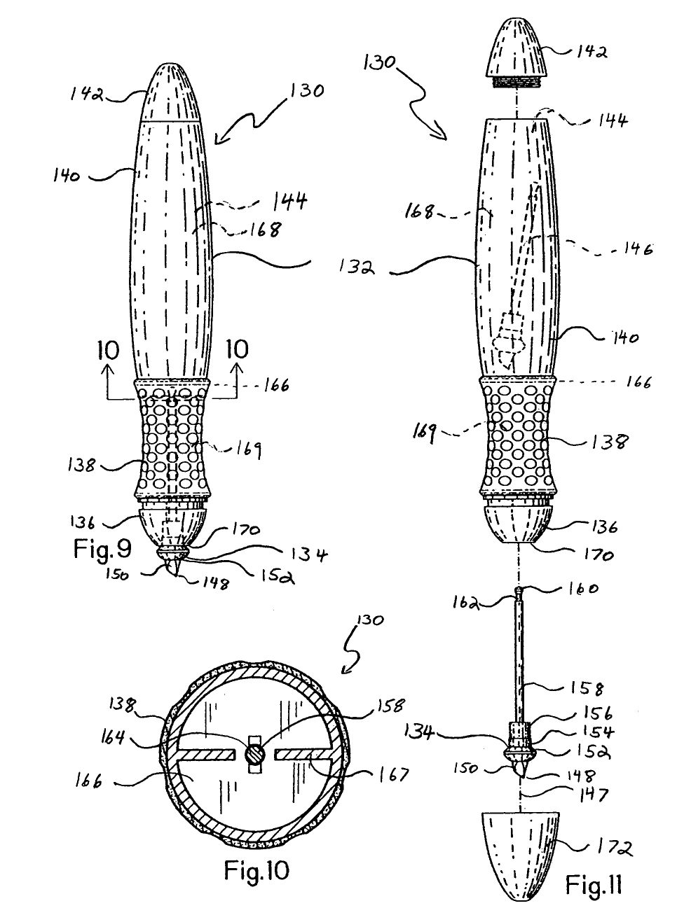

Referring now to FIGS. 9-11, the template cutting assembly 10 utilizes a specialized knife generally designated 130. This knife 130 has a handle 132 and a blade housing 134. The handle 132 is made up sequentially of a removable insertion dome 136 that is preferably threaded, a grip area 138 and a main body 140 adjacent to the grip area. A removable tip 142 is opposite the insertion dome, is also preferably threaded and provides access to a hollow interior 144. At least one extra blade housing 146 (shown hidden) is accommodated in this hollow interior 144. A knife axis 147 (FIG. 11) is defined along the axis formed from the tip 142 to the dome 136.

The handle 132 is preferably manufactured out of a rigid plastic, with the exception being the grip area 138. A pliable, tacky material is preferred for the grip area 138, which is made of a sleeve of material slid over a generally hourglass shaped portion of the handle 132. In the preferred embodiment, the grip area 138 is textured, supplementing the effect of the tacky material and the hourglass shape, all of which prevent a user's fingers from slipping during use.

The blade housing 134 includes a blade 148 at its very tip, the blade housing having a beveled section 150. A radially extending spheroidal stopper 152 is located vertically adjacent the blade 148, followed by a radially narrowed top shaft bushing 154, and a bottom shaft bushing 156. Projected vertically from the bottom shaft bushing 156 is an elongated shaft 158 having a ball 160 at the terminus of the shaft 158, and a radially narrowed neck shaft section 162 connecting the ball 160 to the main shaft 158. The blade 148 is preferably made of steel, and the beveled section 150 which houses it is preferably manufactured by molding the beveled section around the blade 148. In fact, in the illustrated embodiment the beveled section 150, stopper 152, and both shaft bushings 154, 156 are all an integral piece of molded plastic. While molded plastic is the preferred material for these sections, other materials or manufacturing techniques are contemplated. The blade housing 134 is attached to the handle 132 using the ball 160 which engages a slot 164 (FIG. 10) defined in the hollow interior 144 at the grip area 138.

Referring now to FIG. 10, a plastic disc 166 is attached to the inner walls of the handle 132. This disc 166 divides the hollow interior 144 into two portions; a rear portion 167 that houses the extra blade housing 146 and a front portion 168 that mounts the blade housing 134 in use. In the center of the disc 166 is the slot 164. The ball 160 passes through the slot 164 and the neck section 162 engages the slot in a friction fit that retards axial movement of the blade housing 134, while allowing rotation about the knife axis 147. Vertical movement is also prevented by the stopper 152, which rests on an annular bore 170 of the insertion dome 136. The bottom shaft bushing 156 is rotationally engaged in the annular bore 170. Also, the stopper 152 forms a spherical surface against an end of the annular bore 170 to facilitate and support rotation about the knife axis 147. In preferred embodiments, a blade cap 172 is placed over the blade housing 134 and secured by a friction fit over the dome 136 to protect the knife blade 148 when not in use.

When in use, and referring to FIG. 8, the beveling of the beveled section 150 is preferably designed to inversely correspond to or complement the beveling of the guide channels 76. Preferably, the knife 130 is held substantially vertically and the blade housing 134 is pressed into the guide channels 76. Then the knife 130 is drawn along the guide channel 76. As curves in the guide channels 76 are encountered, the blade housing 134 rotates along the knife axis 147, and the substantially flush fit between the beveling of the guide channel and the beveled section 150 of the knife 130 is maintained.

To use the template cutting assembly 10, the material to be cut is placed on the cutting surface 32. The material may be aligned using the guide rail 36 or the gridlines 37. The frame 14 is then closed into the cutting position, locking the sheet material firmly in place under the template 57 of choice. The user then runs the knife 130 through the guide channels 76, thus cutting the material into the desired shape. When the user desires a new template 57 shape or design, the template is slidingly disengaged from the frame 14. A new template 57 is then selected and inserted such that the template rim 72 slidingly engages the track 69 until the template 57 encounters the backstop 54. The template cutting assembly 10 is then ready for use again with the new template 57.

As can be seen the present template cutting assembly 10 addresses and remedies the perceived problems in the prior art. The template cutting assembly 10 provides for interchangeable, anchored templates 57, and the template cutting assembly also limits disturbance to the sheet material being cut through its ratcheting hinge assembly 16. By providing the removable cutting surface 32, scratched, rough, or uneven cutting surfaces can be replaced. Finally, the complimentary beveling of the knife 130 and the guide channels 76 provides greater cutting consistency.

While a particular embodiment of the present template cutting assembly has been described herein, it will be appreciated by those skilled in the art that changes and modifications may be made thereto without departing from the invention in its broader aspects and as set forth in the following claims.

What is claimed is:

1. A device for cutting a medium with a knife blade, comprising:
a base and a frame connected by a hinge assembly for respective movement between a closed, cutting position and an open position;
said base having a first end and a second end, said first end providing a hinge attachment point for said base;
said frame having a first end configured for engaging said hinge attachment point, and a second end; and
a template removably mounted on said frame, and having at least one guide channel for guiding said knife blade for cutting said medium.

2. The device of claim 1, further comprising a cutting surface mounted on said base, wherein said frame is provided with at least one track for slidably engaging said template so that said template is disposed upon said cutting surface in said closed position.

3. The device of claim 2, wherein said template flushly engages said cutting surface when said frame is disposed in said cutting position.

4. The device of claim 1 wherein at least one track depends from an underside of said frame and opens towards an inner side of said frame for slidingly inserting and/or removing said template.

5. The device of claim 4 wherein said track includes a plurality of tabs having different widths.

6. The device of claim 1 wherein said hinge assembly has a ratcheting mechanism to retard and control relative hinge motion of said frame and said base.

7. The device of claim 1 further comprising at least one handle arrayed on said second end of said frame.

8. The device of claim 1 wherein said frame and base have a locking mechanism for releasably retaining said base to said frame in said cutting position.

9. The device of claim 8 wherein said locking mechanism comprises a set of magnets placed in opposing portions of said base and frame.

10. The device of claim 1 further comprising a cutting surface mounted on said base, wherein said cutting surface is removably mounted on said base.

11. The device of claim 1 further comprising a paper guide arrayed on said base.

12. The device of claim 1, wherein said hinge assembly and an associated portion of said frame have complementary angled surfaces for maintaining alignment of said frame with said base in a cutting position.

13. The device of claim 1, wherein said at least one guide channel possesses beveled edges.

14. A system for cutting a medium comprising:
a base and a frame connected by a hinge assembly;
said base having a first end and a second end, said first end providing a hinge attachment point for said base;
said frame having a first end configured for engaging said hinge attachment point, and a second end;
a cutting surface mounted on said base;
a template releasably mounted on said frame and having at least one guide channel; and
a knife with a handle and a blade housing rotatably mounted to said handle, said blade housing having a complementary contoured surface configured for engaging a corresponding edge of said template.

15. The system of claim 14 wherein said template has a beveled edge that complements said contoured surface of said blade housing.

16. The system of claim 14 wherein said blade housing includes an axially projecting shaft, said shaft having an end which engages said handle providing said blade with stability and resistance to lateral movement.

17. The system of claim 16 wherein said handle defines a hollow interior including an accessible storage space.

18. The system of claim 14 further including a plurality of said templates, each being slidably removable from said frame.

19. A knife for use with a template system for cutting a medium, the system including at least one template having at least one guide channel with a beveled edge, said knife comprising:
a handle having a first end and a second end, a grip area disposed between said ends and a hollow interior;
a blade housing releasably attached to said first end and having an edge portion contoured to be complementary to the beveled edge; and
said blade housing having an axial shaft projecting into said interior and configured for being rotatably engaged and secured in said interior.

20. The knife of claim 19 wherein said blade housing includes a radially extending bushing which rotatably engages a bore defined in said first end of said handle, and an apertured disk configured for accommodating an end of said shaft for secured rotation, said blade housing being rotatably supported in said handle at said bushing and at said shaft end.
